(19) United States
(12) Patent Application Publication
(10) Pub. No.: US 2020/0290527 A1
(43) Pub. Date: Sep. 17, 2020

(54) SOUND INSULATION STRUCTURE

(71) Applicant: HONDA MOTOR CO., LTD., Tokyo (JP)

(72) Inventors: Ikumi Kurihara, Wako-shi (JP); Takashi Kondo, Wako-shi (JP); Yoshihiro Noguchi, Wako-shi (JP)

(21) Appl. No.: 16/805,883

(22) Filed: Mar. 2, 2020

(30) Foreign Application Priority Data
Mar. 14, 2019 (JP) 2019-047145

(51) Int. Cl. B60R 13/08; G10K 11/168

(52) U.S. Cl. CPC B60R 13/0815; G10K 11/168

(57) ABSTRACT

A sound insulation structure includes a mass part and a plurality of spring parts. The mass part is arranged to be spaced from a compartment member that compartmentalizes an internal space of a structure body and an outside. At least part of the mass part has a flat surface shape. The spring part is arranged on a side facing the compartment member in the mass part. The spring part includes: a hollow film material having airtightness and flexibility; and a gas encapsulated within the film material. The film material includes a recess part on one surface which is at least one of surfaces on the compartment member side and the mass part side.

### CROSS-REFERENCE TO RELATED APPLICATION

Priority is claimed on Japanese Patent Application No. 2019-047145, filed on Mar. 14, 2019, the contents of which are incorporated herein by reference.

### BACKGROUND

### Field of the Invention

The present invention relates to a sound insulation structure.

### Background

In a vehicle such as an automobile, a building, and the like, in order to prevent noise from entering an internal space from the outside or prevent noise from being leaked from the internal space to the outside, a sound insulation material having a sound insulation performance is provided on a compartment member that compartmentalizes the outside and the internal space.

For example, Japanese Unexamined Patent Application, First Publication No. 2010-265589 discloses a configuration in which a spacer having a plurality of recess parts are arranged as a sound insulation material between a compartment member (roof plate) and a porous base material on an internal space side. According to such a configuration, noise (sound waves) entering from the compartment member side enters the inside of the recess part formed on the spacer and is reflected at the inside of the recess part, and thereby, a sound insulation performance is exerted.

Further, Japanese Unexamined Patent Application, First Publication No. 2003-104135 discloses a configuration in which a urethane layer is mounted as a sound insulation material on a compartment member (vehicle floor plate), noise is attenuated by the urethane layer, and a sound insulation property is exerted. In this configuration, a mass layer having a plate shape is mounted on the urethane layer, and thereby, the configuration includes a sound insulation structure in which the mass layer is used as a mass, and the urethane layer is used as a spring.

Japanese Unexamined Patent Application, First Publication No. 2006-123614 discloses a configuration in which a sound insulation material made of a foamed porous material or a fiber material is arranged in a bag formed of a film, and a sealing gas is sealed in the bag.

### SUMMARY

Enhancing the sound insulation property is always desired. For example, in an automobile, a material that forms an outer panel of a vehicle body may be changed from an iron-based material to an aluminum-based material or a resin-based material, for example, in order to improve a fuel consumption rate by reducing the weight of the automobile or the like. Thereby, the sound insulation property of the outer panel itself may be degraded, and further enhancement of the sound insulation property is required.

However, in conventional techniques such as those disclosed in Japanese Unexamined Patent Application, First Publication No. 2010-265589, Japanese Unexamined Patent Application, First Publication No. 2003-104135, and Japanese Unexamined Patent Application, First Publication No. 2006-123614, in order to further enhance the sound insulation property, it is necessary to increase the thickness of the sound insulation material. However, as the thickness of the sound insulation material increases, the weight and cost increase in accordance with the increase of the usage amount of the sound insulation material.

An aspect of the present invention provides a sound insulation structure capable of enhancing a sound insulation property while preventing a weight increase and a cost increase.

A sound insulation structure according to a first aspect of the present invention includes: a mass part which is arranged to be spaced from a compartment member that compartmentalizes an internal space of a structure body and an outside, and at least part of which has a flat surface shape; and a plurality of spring parts that are arranged on a side facing the compartment member in the mass part, wherein the spring part includes: a hollow film material having airtightness and flexibility; and a gas encapsulated within the film material, and the film material includes a recess part on one surface which is at least one of surfaces on the compartment member side and the mass part side.

A second aspect of the present invention is the sound insulation structure according to the first aspect wherein the recess part may be formed in a circumferential shape.

A third aspect of the present invention is the sound insulation structure according to the first or second aspect which may include a sound insulation member including the mass part and the spring part, wherein the sound insulation member may be provided on a side facing the compartment member of the spring part and may further include a joint layer member capable of being joined to the compartment member.

A fourth aspect of the present invention is the sound insulation structure according to the third aspect, wherein the mass part may be made of a polypropylene, the film material may be made of an ethylene-vinyl alcohol copolymer, and the joint layer member may be made of a polyethylene.

A fifth aspect of the present invention is the sound insulation structure according to any one of the first to fourth aspects, wherein the mass part may be formed of a material having a larger specific gravity than that of the film material of the spring part.

A sixth aspect of the present invention is the sound insulation structure according to any one of the first to fifth aspects, wherein the film material of the spring part may be formed of a material having a lower Young's modulus than that of the mass part.

A seventh aspect of the present invention is the sound insulation structure according to any one of the first to sixth aspects, wherein the plurality of spring parts may be arranged to be spaced from each other in a direction along an opposing surface that opposes the compartment member.

An eighth aspect of the present invention is the sound insulation structure according to any one of the first to seventh aspects, wherein the gas may be an air.

A ninth aspect of the present invention is the sound insulation structure according to any one of the first to seventh aspects, wherein the gas may be a carbon dioxide or a helium.

A tenth aspect of the present invention is the sound insulation structure according to any one of the first to ninth aspects, wherein the structure body may be a vehicle body of an automobile, and the compartment member may be an outer panel of the vehicle body or an inner panel that forms an interior of the vehicle body.

According to the first aspect of the present invention, it is possible to constitute a sound insulation structure in which the mass part is used as a mass, and the spring part is used as a spring. Accordingly, by appropriately adjusting the mass of the mass part and a spring constant of the spring of the spring part, a frequency at which the mass part resonates to noise is adjusted, and it is possible to efficiently reduce the noise in a target frequency range.

Further, since the sound insulation structure is a configuration in which the gas is encapsulated within the hollow film material, the usage amount of a material that forms the film material is greatly less than that of the urethane layer. Accordingly, even if the thickness of the sound insulation structure in a direction in which the mass part and the compartment member face each other is increased, it is possible to enhance a sound insulation property while preventing a weight increase and a cost increase.

Here, the pressure (that is, an internal pressure of the film material) of the gas encapsulated within the film material is varied in response to, for example, an external environment. According to the variation of the pressure of the gas, the spring part is expanded, and it is conceivable that, for example, a layout space of the spring part, a durability of the spring part, the spring constant, and the like are affected.

Therefore, according to the first aspect of the present invention, the recess part is formed on the film material, and the recess part is made deformable in response to the pressure of the gas. Accordingly, by deforming the recess part, for example, in response to a low-pressure environment at a high altitude or a high-temperature environment, it is possible to prevent the variation of the pressure (that is, the internal pressure of the film material) of the gas. Thereby, the expansion of the spring part can be prevented, and, for example, “preventing the spring part from affecting the layout space”, “ensuring the durability of the spring part”, and “ensuring the sound insulation property by preventing the increase of the spring constant” can be realized.

According to the second aspect of the present invention, the recess part is formed in a circumferential shape. Accordingly, for example, it is possible to smoothly deform the entire region of the recess part in response to the low-pressure environment at a high altitude or the high-temperature environment. Thereby, it is possible to favorably prevent the variation of the pressure (that is, the internal pressure of the film material) of the gas.

According to the third aspect of the present invention, the sound insulation member is constituted of the mass part and the spring part, and the joint layer member is provided in the sound insulation member on the side facing the compartment member of the spring part. Thereby, the sound insulation structure can be joined to the compartment member by the joint layer member, and the sound insulation structure can be easily provided on the compartment member.

According to the fourth aspect of the present invention, by forming the mass part using the polypropylene, it is possible to obtain a high moldability. Further, by forming the film material using the ethylene-vinyl alcohol copolymer, a high airtightness can be obtained, and it is possible to prevent the leakage of the gas encapsulated within the film material.

Furthermore, by forming the joint layer member using the polyethylene, the joint layer member can be easily and reliably joined to the compartment member.

According to the fifth aspect of the present invention, the specific gravity of the mass part is larger than the specific gravity of the film material, and thereby, the function of the mass part as the mass can be effectively exerted.

According to the sixth aspect of the present invention, the Young's modulus of the film material is smaller than the Young's modulus of the mass part, and thereby, the spring part is easily deformed elastically, and it is possible to efficiently reduce the noise.

According to the seventh aspect of the present invention, the plurality of spring parts are provided to be spaced from each other in the direction along the opposing surface, and thereby, when the spring part is elastically deformed in accordance with the displacement of the mass part so as to approach and be separated from the compartment member side, it is possible to prevent the spring parts adjacent to each other from interfering with each other. Thereby, it is possible to prevent another spring part from blocking the deformation of the spring part, and it is possible to efficiently reduce the noise.

According to the eighth aspect of the present invention, by using air as the gas encapsulated in the film material, it is possible to reduce costs.

According to the ninth aspect of the present invention, by using carbon dioxide as the gas encapsulated in the film material, a sonic speed (a propagation speed of sound waves) is reduced compared to a case in the air, and it is possible to improve the sound insulation performance Further, by using helium as the gas encapsulated in the film material, a density becomes lower than that of the air, and it is possible to improve the sound insulation performance

According to the tenth aspect of the present invention, the sound insulation structure such as those described above is provided on the inner panel or the outer panel of the vehicle body of the automobile, and thereby, it is possible to enhance the sound insulation property in the internal space of the vehicle body.

### BRIEF DESCRIPTION OF THE DRAWINGS

FIG. 1 is an exploded perspective view showing a vehicle body that includes a sound insulation structure according to an embodiment of the present invention.

FIG. 2 is a cross-sectional view showing a roof part of the vehicle body that includes the sound insulation structure according to the embodiment.

FIG. 3 is a perspective view of the roof part of the vehicle body that includes the sound insulation structure according to the embodiment when seen from a vehicle outside.

FIG. 4 is a cross-sectional view along a IV-IV line of FIG. 3 showing the sound insulation structure according to the embodiment.

FIG. 5 is a bottom view seen from a V arrow direction of FIG. 4 showing an arrangement of a spring part in the sound insulation structure according to the embodiment.

FIG. 6 is a cross-sectional view showing the sound insulation structure according to the embodiment.

FIG. 7 is a view showing a model of the sound insulation structure according to the embodiment.

FIG. 8 is a side view showing a sound insulation structure of a comparison example.

FIG. 9 is a graph showing a transmission loss of the sound insulation structure according to the embodiment and the sound insulation structure according to the comparison example.

FIG. 10 is a cross-sectional view of a sound insulation structure according to a first modified example of the embodiment.

FIG. 11 is a cross-sectional view of a sound insulation structure according to a second modified example of the embodiment.

FIG. 12A is a cross-sectional view of a sound insulation structure according to a third modified example of the embodiment.

FIG. 12B is a plan view of a spring part according to the third modified example of the embodiment.

FIG. 13 is a bottom view showing an arrangement of a spring part in a sound insulation structure according to a fourth modified example of the embodiment.

FIG. 14 is a cross-sectional view along a XIV-XIV line of FIG. 13 in the sound insulation structure according to the fourth modified example of the embodiment.

FIG. 15 is a bottom view showing an arrangement of a spring part in a sound insulation structure according to a fifth modified example of the embodiment.

FIG. 16 is a cross-sectional view showing a roof part of a vehicle body that includes a sound insulation structure according to a sixth modified example of the embodiment.

FIG. 17 is an enlarged cross-sectional view of a main part of the sound insulation structure according to the sixth modified example of the embodiment.

FIG. 18 is a cross-sectional view showing a roof part of a vehicle body that includes a sound insulation structure according to a seventh modified example of the embodiment.

### DESCRIPTION OF EMBODIMENTS

Hereinafter, an embodiment of the present invention will be described with reference to the drawings. In the drawings, an arrow FR indicates a frontward direction of a vehicle, an arrow UP indicates an upward direction of the vehicle, and an arrow LH indicates a leftward direction. The embodiment is described using an example in which a structure body is a vehicle body 1 of an automobile; however, the structure body is not limited to the vehicle body 1 of the automobile.

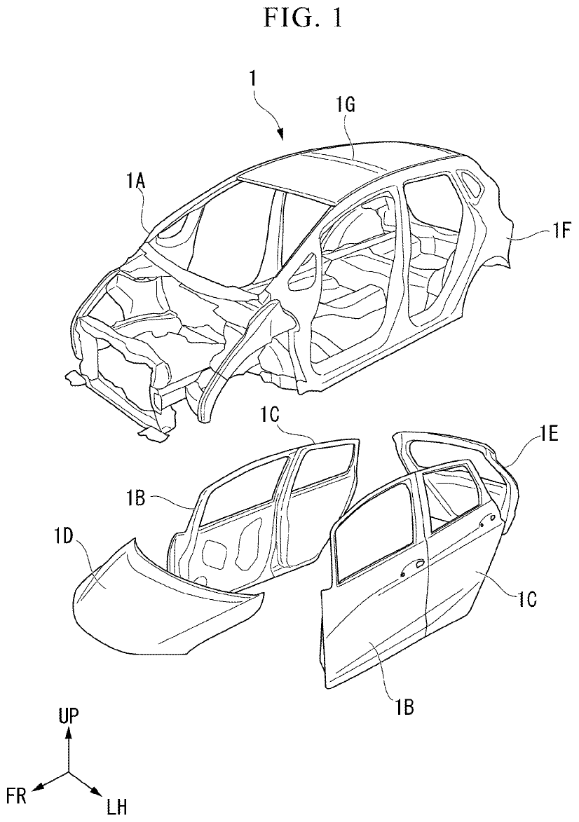

As shown in FIG. 1, the vehicle body 1 of the automobile includes a vehicle body main body 1A, right and left front side doors 1B, right and left rear side doors 1C, a bonnet 1D, a tail gate 1E, right and left quarter panels 1F (the right quarter panel 1F is not shown), and a roof part 1G.

The embodiment is described using an example in which the roof part 1G includes a sound insulation structure; however, the embodiment is not limited thereto. As another example, the right and left front side doors 1B, the right and left rear side doors 1C, the bonnet 1D, the tail gate 1E, the right and left quarter panels 1F, the roof part 1G, or the like can include the sound insulation structure.

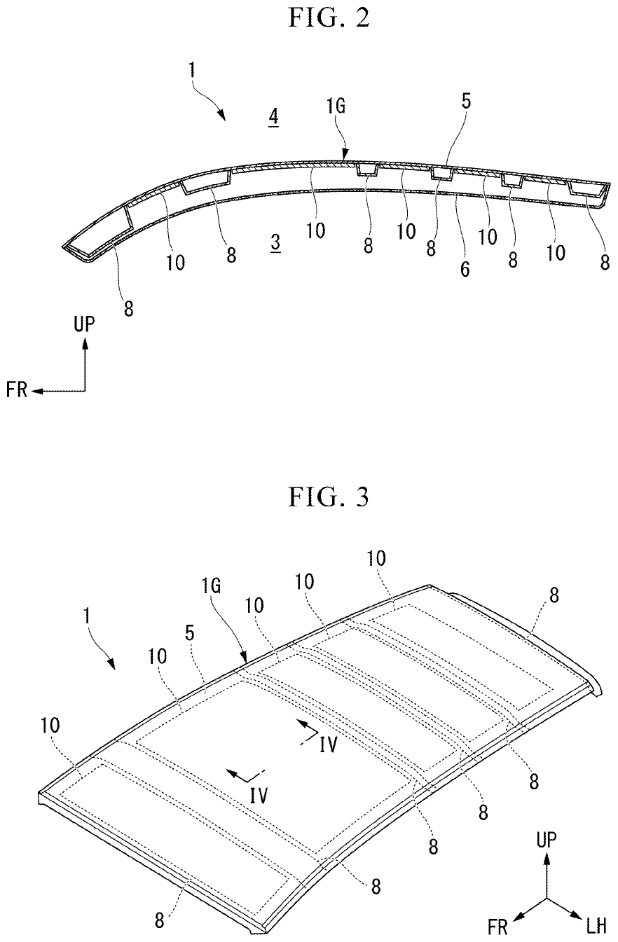

As shown in FIG. 2 and FIG. 3, the sound insulation structure according to the present embodiment includes a sound insulation member 10.

The sound insulation member 10 is provided between an outer panel (compartment member) 5 of the roof part 1G and an inner panel (roof garnish, compartment member) 6 that faces an internal space 3 in the vehicle body 1 and forms an interior. The sound insulation member 10 is fixed to a lower surface of the outer panel 5.

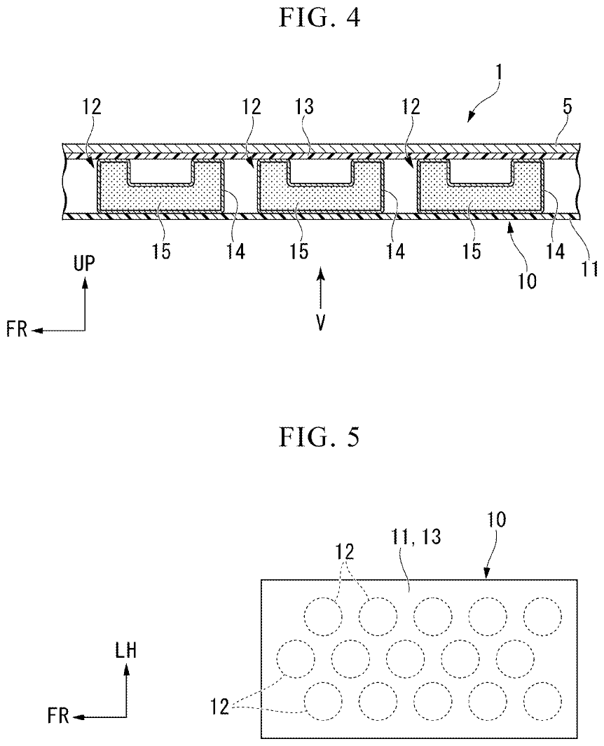

As shown in FIG. 4 and FIG. 5, the sound insulation member 10 includes a mass part 11, a spring part 12, and a joint layer member 13. The sound insulation member 10 is arranged in a space between the outer panel 5 and the inner panel 6 (refer to FIG. 2).

The mass part 11 has, for example, a plate shape and is arranged to be spaced from the outer panel 5 that compartmentalizes the internal space 3 of the vehicle body 1 and an outside 4 (refer to FIG. 2). The mass part 11 can be preferably formed of a material having a higher formability and a larger specific gravity than that of a film material 14 of the spring part 12 described below.

For example, polypropylene (PP) can be preferably used as a material that forms such a mass part 11. The shape of the mass part 11 is not limited to a plate shape, and the mass part 11 may be a member having a flat surface shape at least in part.

A plurality of spring parts 12 are arranged to be spaced from each other along an opposing surface on a side that opposes the outer panel 5 in the mass part 11. In the present embodiment, the spring parts 12 are arranged in a stagger form along the mass part 11.

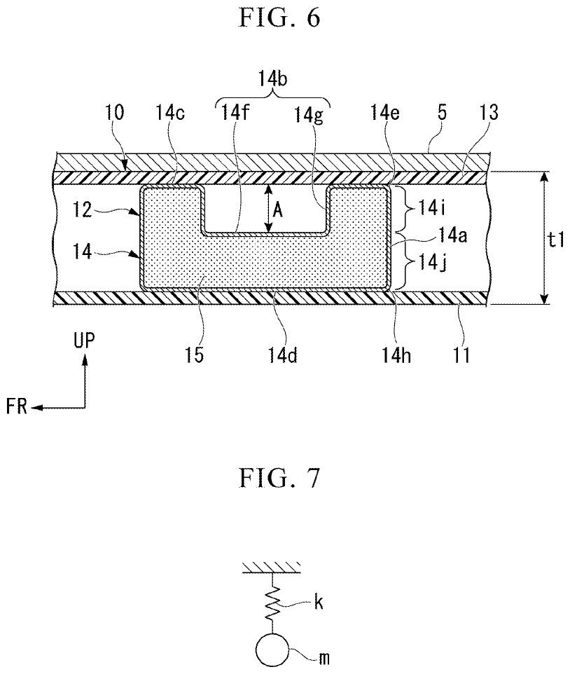

Each spring part 12 includes a hollow film material 14 and a gas 15 (also refer to FIG. 6) encapsulated within the film material 14.

As shown in FIG. 6, the film material 14 defines a tubular shape that extends in a direction as an axis line in which the mass part 11 and the outer panel 5 face each other. The film material 14 defines a sealed container shape that integrally includes a tubular part 14a, a recess 14b, a first end closure part (one surface) 14c, and a second end closure part (one surface) 14d. The film material 14 is formed of a material having airtightness and flexibility.

The film material 14 can be preferably formed of a material having a lower Young's modulus than that of a material forming the mass part 11 such that the film material 14 is elastically deformed more actively than the mass part 11. For example, ethylene-vinyl alcohol copolymer (for example, Kuraray “EVAL” (registered trademark)) can be preferably used as the material forming such a film material 14. The “airtightness” of the film material 14 is not limited to forming a closed space having completely no inflow or outflow of air, but it is also possible to permit some inflow and outflow of air such that the film material 14 can function as the spring part.

The tubular part 14a is formed such that the cross-sectional shape seen from the direction in which the mass part 11 and the outer panel 5 face each other is, for example, a circular tubular shape. A first end part 14e on the outer panel 5 side of the tubular part 14a is closed by the first end closure part 14c and the recess part 14b. The first end closure part 14c is formed in a flat annular shape along the outer panel 5. The first end closure part 14c is integrally joined, for example, to the outer panel 5 by the joint layer member 13. The joint layer member 13 is described later in detail.

The recess part 14b is formed in a recess shape on an inner circumferential portion of the first end closure part 14c. The recess part 14b is formed, for example, coaxially with respect to the tubular part 14a. The recess part 14b has a bottom portion 14f and a side wall 14g. The bottom portion 14f is formed in a flat circular plate along the outer panel 5. The bottom portion 14f is arranged to be spaced toward the mass part 11 side relative to the first end closure part 14c.

The side wall 14g extends cylindrically toward the outer panel 5 side from an outer circumference of the bottom portion 14f to an inner circumferential portion of the first end closure part 14c. The side wall 14g is formed such that the cross-sectional shape seen from the direction in which the mass part 11 and the outer panel 5 face each other is, for example, a circumferential shape. That is, the recess part 14b is formed in a circumferential recess shape.

A second end part 14h on the mass part 11 side of the tubular part 14a is closed by the second end closure part 14d. The second end closure part 14d is formed to be flat along the mass part 11. The second end closure part 14d is integrally joined, for example, to the mass part 11 by an adhesive, welding, or the like.

That is, the film material 14 of the spring part 12 has the recess part 14b at the first end closure part 14c on the outer panel 5 side. Accordingly, the film material 14 is set (adjusted) such that a cross-sectional area of a region 14i that includes the recess part 14b is smaller than that of another region 14j. Thereby, a spring constant k (refer to FIG. 7) of the spring part 12 can be preferably lowered, and a resonance frequency by the sound insulation member 10 can be lowered.

Further, the recess part 14b is formed to be deformable in response to the pressure of a gas 15 encapsulated within the film material 14. That is, for example, the recess part 14b is formed such that, by deforming the side wall 14g in response to the pressure of the gas 15, the bottom portion 14f is movable in an arrow A direction (that is, in the direction in which the mass part 11 and the outer panel 5 face each other).

Thereby, by deforming the recess part 14b, for example, in response to a low-pressure environment at a high altitude or a high-temperature environment, it is possible to prevent the variation of the pressure (that is, the internal pressure of the film material 14) of the gas 15.

Accordingly, the expansion of the spring part 12 can be prevented, and, for example, “preventing the spring part 12 from affecting the layout space”, “ensuring the durability of the spring part 12”, and “ensuring the sound insulation property by preventing the increase of the spring constant k” can be realized.

The side wall 14g is formed in a circumferential shape. Therefore, for example, it is possible to smoothly deform the entire region of the recess part 14b in response to the low-pressure environment at a high altitude or the high-temperature environment. Thereby, it is possible to favorably prevent the variation of the pressure (that is, the internal pressure of the film material 14) of the gas 15.

The detailed reason for the first end closure part 14c of the film material 14 including the recess part 14b will be described below in detail.

The embodiment is described using an example in which the recess part 14b is formed on the first end closure part 14c on the outer panel 5 side; however, the embodiment is not limited thereto. As another example, the recess part 14b can be formed on the second end closure part 14d on the mass part 11 side.

The gas 15 is filled in the inside of the hollow film material 14 to a preset pressure or more at least such that the looseness of the film material 14 is eliminated.

For example, air can be used as such gas 15.

Further, carbon dioxide and helium can be also used as the gas 15.

The joint layer member 13 is provided on a side facing the outer panel 5 in the spring part 12. In this embodiment, the joint layer member 13 defines a membrane shape and is formed to cover a plurality of spring parts 12 (refer to FIG. 4).

Such a joint layer member 13 is formed of a material capable of being joined to the outer panel 5. In this embodiment, the joint layer member 13 is joined to the outer panel 5 by welding using ultrasonic waves, heat, or the like. Therefore, the joint layer member 13 can be preferably formed of a material having an excellent weldability with respect to the outer panel 5. For example, polyethylene (PE) can be used as the material that forms such a joint layer member 13. The joint layer member 13 may be joined to the outer panel 5 by an adhesive layer or an adhesive agent.

The joint layer member 13 is provided on only the first end closure part 14c on the outer panel 5 side of each spring part 12; however, the embodiment is not limited thereto. As another example, the joint layer member 13 may be provided on the second end closure part 14d on the mass part 11 side of each spring part 12 and may be joined to the mass part 11.

The mass part 11, the spring part 12, and the joint layer member 13 that constitute the sound insulation member 10 are joined together and integrated by an adhesive, welding, or the like.

As shown in FIG. 2 and FIG. 3, the sound insulation member 10 is provided at a position that avoids a reinforcement frame (roof cross member) 8 provided on the outer panel 5 relative to the outer panel 5 of the vehicle body 1. In this embodiment, the sound insulation member 10 is formed, between adjacent reinforcement frames 8, in a band shape that extends longitudinally along the direction in which the reinforcement frame 8 extends. In this way, the sound insulation member 10 can be formed in accordance with the shape of the outer panel 5 or the arrangement of the reinforcement frame 8 or another member provided on the outer panel 5. The shape of the sound insulation member 10 is not limited to a quadrangular shape, and the sound insulation member 10 can be formed into a triangular shape, a trapezoidal shape, or a variety of other shapes.

As shown in FIG. 6 and FIG. 7, the sound insulation member 10 includes the mass part 11 and the spring part 12 and thereby constitutes a sound insulation structure in which the mass part 11 is used as a mass m, and the spring part 12 is used a spring having a spring constant k. In the sound insulation member 10 having such a sound insulation structure, the mass m and the spring constant k are adjusted by adjusting the weight of the mass part 11 and the pressure of the gas 15 encapsulated in the film material 14 constituting the spring part 12.

As described above, the sound insulation member 10 includes the mass part 11 and the spring part 12, and the spring part 12 is formed by encapsulating the gas 15 within the hollow film material 14.

In this way, the sound insulation member 10 can constitute a sound insulation structure in which the mass part 11 is used as a mass m, and the spring part 12 is used as a spring having a spring constant k. Further, by adjusting the pressure of the gas 15 encapsulated within the film material 14, it is possible to adjust the spring constant k of the spring part 12. Furthermore, since the spring part 12 is a configuration in which the gas 15 is encapsulated within the hollow film material 14, the usage amount of a material that forms the film material 14 is greatly less than that of the urethane layer. Thereby, even if the thickness (that is, the thickness t1 of the sound insulation member 10) of the spring part 12 in a direction in which the mass part 11 and the outer panel 5 face each other is increased in order to enhance a sound insulation property, it is possible to prevent a cost increase and a weight increase of the spring part 12.

Accordingly, it is possible to enhance the sound insulation property while preventing the weight increase and the cost increase.

Further, the joint layer member 13 is provided on the side facing the outer panel 5 in the spring part 12.

Thereby, the sound insulation member 10 can be joined by the joint layer member 13 and be attached to the outer panel 5.

Further, by forming the mass part 11 using the polypropylene, it is possible to obtain a high moldability. Further, by forming the film material 14 using the ethylene-vinyl alcohol copolymer, a high airtightness can be obtained, and it is possible to prevent the leakage of the gas 15 encapsulated within the film material 14. Furthermore, by forming the joint layer member 13 using the polyethylene, the joint layer member 13 can be easily and reliably welded to the outer panel 5.

Further, the specific gravity of the mass part 11 is larger than the specific gravity of the film material 14.

Thereby, the function of the mass part 11 as the mass can be effectively exerted.

Further, the Young's modulus of the film material 14 is smaller than the Young's modulus of the mass part 11.

Thereby, the spring part 12 is easily deformed elastically, and it is possible to efficiently reduce the noise.

Further, the plurality of spring parts 12 are provided to be spaced from each other in the direction along the opposing surface.

Thereby, when the spring part 12 is elastically deformed in accordance with the displacement of the mass part 11 so as to approach and be separated from the outer panel 5 side, it is possible to prevent the spring parts 12 adjacent to each other from interfering with each other. Thereby, it is possible to prevent another spring part 12 from blocking the deformation of the spring part 12, and it is possible to efficiently reduce the noise.

Further, air is used as the gas 15 encapsulated in the film material 14.

Thereby, it is possible to reduce costs of the sound insulation member 10.

Further, by using carbon dioxide as the gas 15 encapsulated in the film material 14, a sonic speed (a propagation speed of sound waves) is reduced compared to a case in the air. Thereby, it is possible to improve the sound insulation performance.

Further, by using helium as the gas 15 encapsulated in the film material 14, the density becomes lower than that of the air. Thereby, it is possible to improve the sound insulation performance

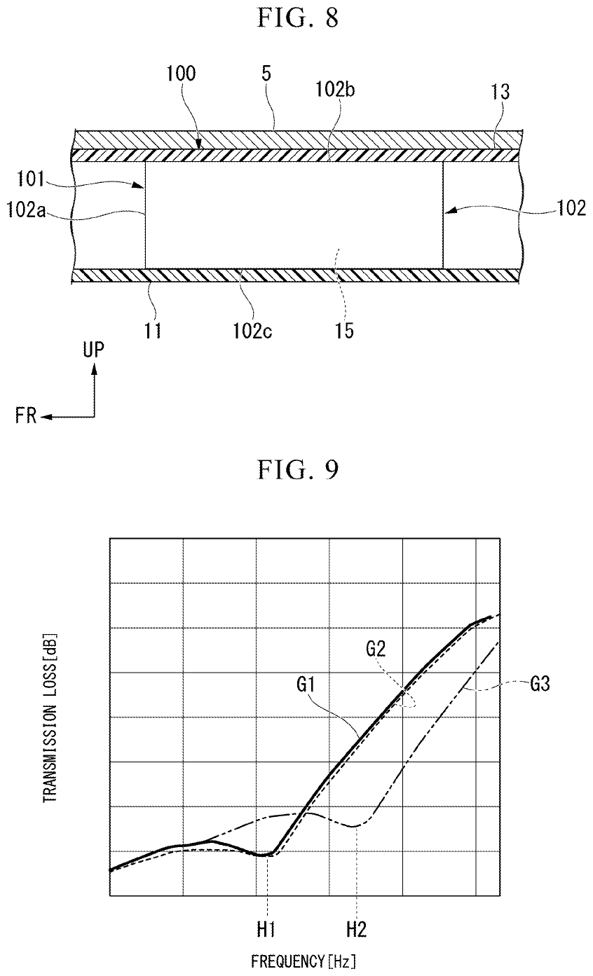

Next, the reason for the film material 14 including the recess part 14b will be described with reference to FIG. 6, FIG. 8, and FIG. 9. FIG. 6 shows the sound insulation member 10 of the embodiment, and FIG. 8 shows a sound insulation member 100 of a comparison example. FIG. 9 is a graph showing transmission losses of the sound insulation member 10 and the sound insulation member 100. In the graph of FIG. 9, the vertical axis represents transmission loss (dB) and the horizontal axis represents frequency (Hz).

As shown in FIG. 8, in the sound insulation member 100 of the comparison example, the spring part 12 of the embodiment is replaced by a spring part 101, and other configurations are similar to those of the sound insulation member 10. The spring part 101 includes a hollow film material 102 and a gas 15 encapsulated within the film material 102.

The film material 102 defines a tubular shape that extends in a direction as an axis line in which the mass part 11 and the outer panel 5 face each other. The film material 102 defines a sealed container shape that integrally includes a tubular part 102a, for example, having a circular cross-sectional shape when seen from the direction in which the mass part 11 and the outer panel 5 face each other, a first end closure part 102b that closes an end part on the joint layer member 13 side of the tubular part 102a, and a second end closure part 102c that closes an end part on the mass part 11 side of the tubular part 102a.

That is, the film material 102 of the comparison example only differs from the film material 14 in that the recess part 14b is removed from the film material 14 of the embodiment shown in FIG. 6, and other configurations are similar to those of the film material 14 of the embodiment.

With reference back to FIG. 8, the spring part 101 of the comparison example does not include the recess part 14b of the embodiment in the film material 102. Therefore, it is conceivable that the pressure (that is, the internal pressure of the film material 102) of the gas 15 encapsulated within the film material 102 is varied in response to, for example, an external environment. It is conceivable that, according to the variation of the pressure of the gas 15, the spring part 101 is expanded, and for example, a layout space of the spring part 101, a durability of the spring part 101, the spring constant, and the like are affected.

Hereinafter, transmission losses of the sound insulation member 100 of the comparison example and the sound insulation member 10 of the embodiment will be described with reference to FIG. 9. In FIG. 9, the graph G1 shows a transmission loss when the sound insulation member 10 of the embodiment is used in an ordinary-pressure environment. The graph G2 shows a transmission loss when the sound insulation member 10 of the embodiment is used in a low-pressure environment at a high altitude. The graph G3 shows a transmission loss when the sound insulation member 100 of the comparison example is used in the low-pressure environment at a high altitude.

In the graph G1 and graph G2, the resonance frequency is a frequency H1, and in the graph G3, the resonance frequency is a frequency H2.

In the spring part 12 of the sound insulation member 10 of the embodiment, the film material 14 includes the recess part 14b. Accordingly, by deforming the recess part 14b in response to the low-pressure environment at a high altitude, it is possible to prevent the variation of the pressure (that is, the internal pressure of the film material 14) of the gas 15. That is, in a low-pressure environment, the expansion of the spring part 12 can be prevented, and it is possible to ensure that the resonance frequency of the graph G2 is the same as the resonance frequency H1 of the graph G1 (that is, an ordinary-pressure environment).

Thereby, as shown in the graph G1 and the graph G2, according to the sound insulation member 10 of the embodiment, it is possible to ensure the transmission loss in the low-pressure environment similarly to the ordinary-pressure environment, and the sound insulation property can be ensured.

On the other hand, in the spring part 101 of the comparison example, the film material 102 does not include the recess part 14b of the embodiment.

Therefore, it is conceivable that the pressure (that is, the internal pressure of the film material 102) of the gas 15 encapsulated within the film material 102 is varied in response to the low-pressure environment at a high altitude. Due to the variation of the pressure of the gas 15, the spring part 101 is expanded, the durability of the spring part 101, the spring constant, and the like are affected, and the resonance frequency of the graph G3 is increased to the frequency H2.

In this way, as shown in the graph G3, according to the sound insulation member 100 of the comparison example, in the low-pressure environment at a high altitude, the resonance frequency is increased to the frequency H2, and thereby, the transmission loss is reduced. Therefore, it is difficult to ensure the sound insulation property in the low-pressure environment similarly to the ordinary-pressure environment.

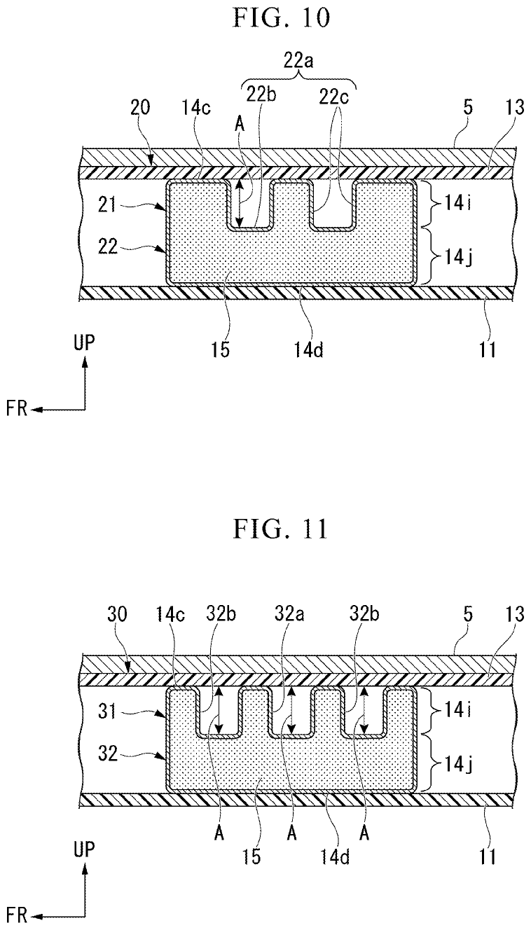

Hereinafter, first to seventh modified examples of the embodiment will be described with reference to FIG. 10 to FIG. 18. In the first to seventh modified examples, the same reference numerals are given to the same and analogous configurations as those of the embodiment, and detailed description of the configurations is omitted.

### First Modified Example of Embodiment

A first modified example of the embodiment is described with reference to FIG. 10.

As shown in FIG. 10, in a sound insulation member 20, a spring part 21 is constituted of a film material 22 and a gas 15. In the film material 22, the recess part 14b of the embodiment is replaced by a recess part 22a, and other configurations are similar to those of the film material 14 of the embodiment.

The recess part 22a is formed on the first end closure part 14c of the film material 22 to have an annular shape such that the recess part 22a is coaxial with respect to the film material 22. The recess part 22a includes a bottom part 22b and a side wall 22c. The side wall 22c is formed in a circumferential shape. That is, the recess part 22a is formed in a circumferential recess shape.

The recess part 22a is formed on the first end closure part 14c of the film material 22, and thereby, a cross-sectional area of a region 14i that includes the recess part 22a is set (adjusted) to be smaller than that of another region 14j. Thereby, the spring constant of the spring part 21 can be preferably lowered, and the resonance frequency by the sound insulation member 20 can be lowered.

Further, the recess part 22a is formed to be deformable in response to the pressure of the gas 15 encapsulated within the film material 22. For example, the recess part 22a is formed such that, by deforming a side wall 22c in response to the pressure of the gas 15, a bottom portion 22b is movable in an arrow A direction (that is, in the direction in which the mass part 11 and the outer panel 5 face each other).

Therefore, by deforming the recess part 22a, for example, in response to a low-pressure environment at a high altitude or a high-temperature environment, it is possible to prevent the variation of the pressure (that is, the internal pressure of the film material 22) of the gas 15.

Thereby, the expansion of the spring part 21 can be prevented, and “preventing the spring part 21 from affecting the layout space”, “ensuring the durability of the spring part 21”, and “ensuring the sound insulation property by preventing the increase of the spring constant” can be realized.

The side wall 22c is formed in a circumferential shape. Therefore, for example, it is possible to smoothly deform the entire region of the recess part 22a in response to the low-pressure environment at a high altitude or the high-temperature environment. Thereby, it is possible to favorably prevent the variation of the pressure (that is, the internal pressure of the film material 22) of the gas 15.

The first modified example is described using an example in which the recess part 22a is formed on the first end closure part 14c on the outer panel 5 side; however, the embodiment is not limited thereto. As another example, the recess part 22a can be formed on the second end closure part 14d on the mass part 11 side.

### Second Modified Example of Embodiment

A second modified example of the embodiment is described with reference to FIG. 11.

As shown in FIG. 11, in a sound insulation member 30, a spring part 31 is constituted of a film material 32 and a gas 15. In the film material 32, the recess part 14b of the embodiment is replaced by a first recess part (recess part) 32a and a second recess part (recess part) 32b, and other configurations are similar to those of the film material 14 of the embodiment.

The first recess part 32a is formed in a circumferential recess shape coaxially with respect to the film material 32 similarly to the recess part 14b of the embodiment. The second recess part 32b is formed in an annular recess shape (circumferential recess shape) such that the second recess part 32b is coaxial with respect to the film material 22 similarly to the recess part 22a of the first modified example.

The first recess part 32a and the second recess part 32b are formed on the first end closure part 14c of the film material 32, and thereby, a cross-sectional area of a region 14i that includes the first recess part 32a and the second recess part 32b is set (adjusted) to be smaller than that of another region 14j. Thereby, the spring constant of the spring part 31 can be preferably lowered, and the resonance frequency by the sound insulation member 30 can be lowered.

Further, the first recess part 32a and the second recess part 32b are formed to be deformable in response to the pressure of the gas 15 encapsulated within the film material 32. For example, the first recess part 32a and the second recess part 32b are formed such that, by deforming a side wall in response to the pressure of the gas 15, a bottom portion is movable in an arrow A direction (that is, in the direction in which the mass part 11 and the outer panel 5 face each other).

Therefore, by deforming the first recess part 32a and the second recess part 32b, for example, in response to a low-pressure environment at a high altitude or a high-temperature environment, it is possible to prevent the variation of the pressure (that is, the internal pressure of the film material 32) of the gas 15.

Thereby, the expansion of the spring part 31 can be prevented, and “preventing the spring part 31 from affecting the layout space”, “ensuring the durability of the spring part 31”, and “ensuring the sound insulation property by preventing the increase of the spring constant” can be realized.

The side walls of the first recess part 32a and the second recess part 32b are formed in a circumferential shape. Therefore, for example, it is possible to smoothly deform the entire region of the first recess part 32a and the second recess part 32b in response to the low-pressure environment at a high altitude or the high-temperature environment. Thereby, it is possible to favorably prevent the variation of the pressure (that is, the internal pressure of the film material 32) of the gas 15.

The second modified example is described using an example in which the first recess part 32a and the second recess part 32b are formed on the first end closure part 14c on the outer panel 5 side; however, the embodiment is not limited thereto. As another example, the first recess part 32a and the second recess part 32b can be formed on the second end closure part 14d on the mass part 11 side.

### Third Modified Example of Embodiment

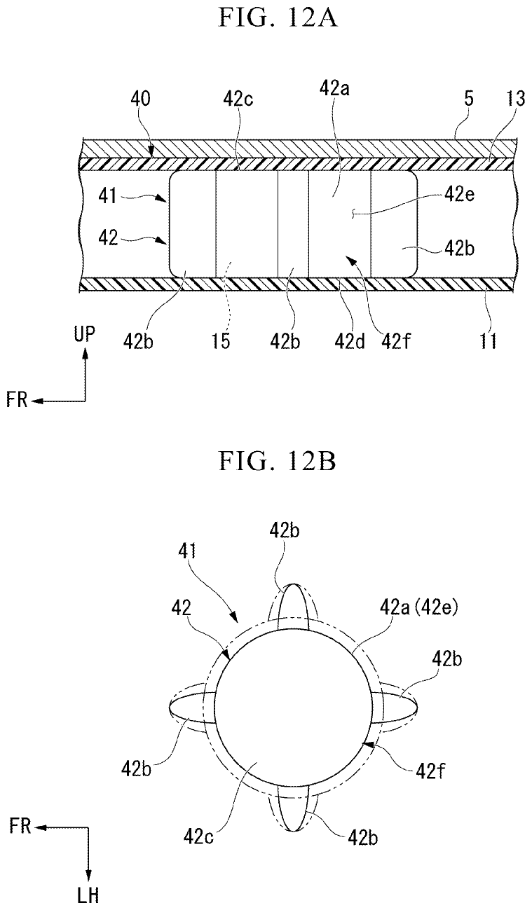

A third modified example of the embodiment is described with reference to FIG. 12A and FIG. 12B.

As shown in FIG. 12A and FIG. 12B, in a sound insulation member 40, a spring part 41 is constituted of a film material 42 and a gas 15. The film material 42 defines a sealed container shape that integrally includes a tubular part 42a, a plurality of protrusion parts 42b, a first end closure part 42c, and a second end closure part 42d. The film material 42 is formed of a material having airtightness and flexibility similarly to the film material 14 of the embodiment.

The tubular part 42a is formed such that the cross-sectional shape seen from the direction in which the mass part 11 and the outer panel 5 face each other is, for example, a circular tubular shape. The inside of the tubular part 42a communicates with the insides of the plurality of protrusion parts 42b. The plurality of protrusion parts 42b radially protrude from an outer circumferential wall 42e of the tubular part 42a to be spaced from each other in the circumferential direction. Therefore, a plurality of recess parts 42f is formed of adjacent protrusion parts 42b and the outer circumferential wall 42e between the adjacent protrusion parts 42b along the outer circumferential wall 42e.

The recess part 42f is provided in a state of opening to both sides of the outer panel 5 and the mass part 11. The number of the plurality of protrusion parts 42b (that is, the plurality of recess parts 42f) can be arbitrarily selected.

In the tubular part 42a and the plurality of protrusion parts 42b, a first end part on the outer panel 5 side is closed by the first end closure part 42c. The first end closure part 42c is integrally joined, for example, to the outer panel 5 by the joint layer member 13 similarly to the first end closure part 14c of the embodiment.

In the tubular part 42a and the plurality of protrusion parts 42b, a second end part on the mass part 11 side is closed by the second end closure part 42d. The second end closure part 42d is integrally joined, for example, to the mass part 11 by an adhesive, welding, or the like similarly to the second end closure part 14d of the embodiment.

The recess part 42f is formed of the adjacent protrusion parts 42b and the outer circumferential wall 42e between the adjacent protrusion parts 42b. Therefore, the recess part 42f is formed to be deformable in a shape indicated by an imaginary line of FIG. 12B according to the deformation of the protrusion part 42b and the outer circumferential wall 42e in response to the pressure of the gas 15 encapsulated within the film material 22.

Thereby, for example, it is possible to prevent the variation of the pressure (that is, the internal pressure of the film material 42) of the gas 15 by deforming the recess part 42f in response to the low-pressure environment at a high altitude or the high-temperature environment.

Accordingly, the expansion of the spring part 41 can be prevented, and “preventing the spring part 41 from affecting the layout space”, “ensuring the durability of the spring part 41”, and “ensuring the sound insulation property by preventing the increase of the spring constant” can be realized.

### Fourth Modified Example of Embodiment

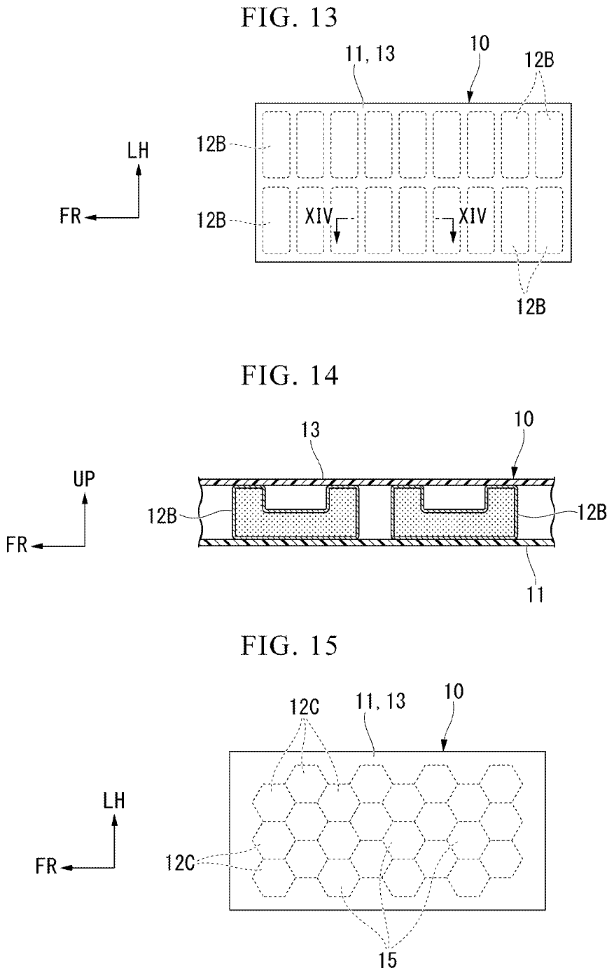

A fourth modified example of the embodiment is described with reference to FIG. 13 and FIG. 14.

In the above-described embodiment, each spring part 12 (refer to FIG. 6) is defined as a circular shape in a cross-section; however, the shape is not limited thereto. For example, as shown in FIG. 13 and FIG. 14, the spring part 12B may be formed in a substantially rectangular shape having a larger cross-sectional area than the spring part 12 of the above-described embodiment. Thereby, the encapsulation area of the gas 15 of the spring part 12B can be increased compared to that of the spring part 12 of the embodiment.

In this case, the spacing between spring parts 12B adjacent to each other may be narrower than the spacing between the spring parts 12 in the embodiment.

### Fifth Modified Example of Embodiment

A fifth modified example of the embodiment is described with reference to FIG. 5.

As shown in FIG. 15, the spring part 12C can be formed in a so-called honeycomb configuration in which the cross-sectional shape is a hexagonal shape, and the spring parts 12C adjacent to each other are arranged with no clearance gap. By forming the spring part 12C in the honeycomb configuration, the encapsulation area of the gas 15 of the spring part 12C can be increased compared to the spring part 12 of the embodiment.

### Sixth Modified Example of Embodiment

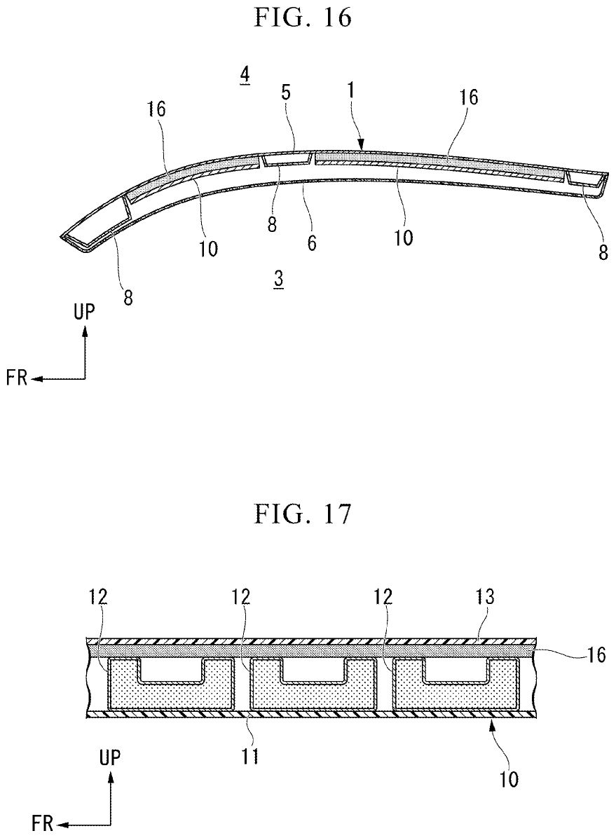

A sixth modified example of the embodiment is described with reference to FIG. 16 and FIG. 17.

In the sound insulation member 10 described above, a hard board material 16 can be added on the joint layer member 13 side as shown in FIG. 16 and FIG. 17. In this case, the board material 16 can be formed of a resin material or the like that is harder than the film material 14. Such a board material 16 can be provided to be interposed between the spring part 12 and the joint layer member 13.

### Seventh Modified Example of Embodiment

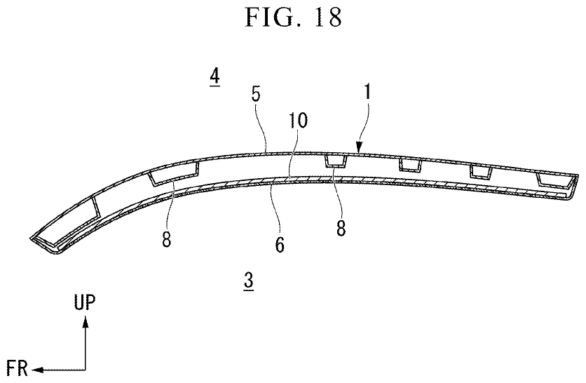

A seventh modified example of the embodiment is described with reference to FIG. 18.

As shown in FIG. 18, for example, the sound insulation member 10 can be mounted not on the outer panel 5 side but on the inner panel 6 side. In this case, the sound insulation member 10 can be provided such that the joint layer member 13 is joined to the inner panel 6, and the mass part 11 is located on the outer panel 5 side.

The present invention is not limited to the embodiment and the modified examples of the embodiment described with reference to the drawings, and various modified examples are conceivable in the technical scope of the invention.

For example, the mass part 11 and the film material 14, 22, 32, 42 may be integrally molded. Thereby, it is not necessary to join the mass part 11 and the film material 14, 22, 32, 42, and the sound insulation member 10 can be efficiently manufactured.

For example, in the embodiment and the modified examples of the embodiment described above, the sound insulation member 10 is provided on the roof part 1G of the vehicle body 1; however, the embodiment is not limited thereto. The sound insulation member 10 may be provided on another region such as the right and left front side doors 1B, the right and left rear side doors 1C, the bonnet 1D, the tail gate 1E, the right and left quarter panels 1F, and the roof part 1G. In the above embodiment, the sound insulation member 10 is provided on the automobile; however, the embodiment is not limited thereto. The sound insulation member 10 may be provided on another structure body such as a ceiling, a wall, and a floor of a building, and a cover of various devices.

Although manufacturing and handling are facilitated by the sound insulation structure being constituted of the sound insulation member 10 independent of the vehicle body 1, a sound insulation structure including the mass part 11 and the spring part 12, 12B, 12C, 21, 31, 41 may be provided directly on the compartment member.

For example, the embodiment is described using an example in which the recess part 14b, 22a, the first recess part 32a, and the second recess part 32b are formed in a circumferential recess shape; however, these recess parts can be formed in a recess having another shape.

The configuration in the above-described embodiment is an example of the present invention, and various changes can made without departing from the scope of the present invention.

What is claimed is:

1. A sound insulation structure comprising:
a mass part which is arranged to be spaced from a compartment member that compartmentalizes an internal space of a structure body and an outside, and at least part of which has a flat surface shape; and
a plurality of spring parts that are arranged on a side facing the compartment member in the mass part,
wherein the spring part comprises: a hollow film material having airtightness and flexibility; and a gas encapsulated within the film material, and
the film material includes a recess part on one surface which is at least one of surfaces on the compartment member side and the mass part side.

2. The sound insulation structure according to claim 1,
wherein the recess part is formed in a circumferential shape.

3. The sound insulation structure according to claim 2, comprising
a sound insulation member including the mass part and the spring part,
wherein the sound insulation member is provided on a side facing the compartment member of the spring part and further comprises a joint layer member capable of being joined to the compartment member.

4. The sound insulation structure according to claim 3,
wherein the mass part is made of a polypropylene,
the film material is made of an ethylene-vinyl alcohol copolymer, and
the joint layer member is made of a polyethylene.

5. The sound insulation structure according to claim 1,
wherein the mass part is formed of a material having a larger specific gravity than that of the film material of the spring part.

6. The sound insulation structure according to claim 1,
wherein the film material of the spring part is formed of a material having a lower Young's modulus than that of the mass part.

7. The sound insulation structure according to claim 1,
wherein the plurality of spring parts are arranged to be spaced from each other in a direction along an opposing surface that opposes the compartment member.

8. The sound insulation structure according to claim 1,
wherein the gas is an air.

9. The sound insulation structure according to claim 1,
the gas is a carbon dioxide or a helium.

10. The sound insulation structure according to claim 1,
wherein the structure body is a vehicle body of an automobile, and the compartment member is an outer panel of the vehicle body or an inner panel that forms an interior of the vehicle body.
